(19) United States
(12) Patent Application Publication
(10) Pub. No.: US 2009/0244608 A1
(43) Pub. Date: Oct. 1, 2009

(54) Image-Output Control Device, Method of Controlling Image-Output, Program for Controlling Image-Output, and Printing Device

(75) Inventor: Hiroyuki TSUJI, Kagoshima-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/403,176

(22) Filed: Mar. 12, 2009

(30) Foreign Application Priority Data
Mar. 27, 2008 (JP) 2008-084249

(51) Int. Cl. G06F 3/12

(52) U.S. Cl. 358/1.15

(57) ABSTRACT

An image-output control device includes a detection unit that detects a predetermined image from a target image and an output control unit that outputs menu display, which is a menu display that can receive selection of a process to be performed for the target image and the predetermined image, for each predetermined image detected from the target image to a predetermined output target.

### BACKGROUND

1. Technical Field

The present invention relates to an image-output control device, a method of controlling image output, a program for controlling image output, and a printing device.

2. Related Art

Users print arbitrary photographs (for example, an identification photograph (ID photo) that is used for a resume, a driver's license, a passport, or the like) by using printers. As technology related thereto, a printing device in which a user selects an ID photo mode from a selection screen of a printing mode, then, selection of the type of a printing sheet and the size of an ID photo is received from the user, selection of an image to be printed as the ID photo is received from the user, then, a face area is extracted from the selected image, an area (clip area) including the extracted face area which will be printed as the ID photo is determined, and an image of the clip area is printed on the selected printing sheet has been known (see JP-A-2007-253488).

In JP-A-2007-253488, the user selects the ID photo mode by operating an operation panel, watching a display, sequentially checks a plurality of images that is read out from a memory card to be displayed in the display, and selects an image desired to be printed as an ID photo. However, to determine whether an image is appropriate as an ID photo while checking contents of images that is photographed and stored in the memory card one after another is a heavy load for the user. In particular, when a plurality of images is saved in the memory card, a load needed for the determination is increased further.

In addition, even when a plurality of face images (predetermined images) is included in one image, the user may hesitate to determine a face image that is appropriate as the ID photo. Furthermore, even when a correction process or the like is performed for an image face, it is too troublesome for the user to determine a correction process that is appropriate to each face image.

### SUMMARY

An advantage of some aspects of the invention is that it provides an image-output control device, a method of controlling image output, an image-output control program, and a printing device capable of allowing a user to easily recognize and perform selection of processes appropriate to each predetermined image such as a face image.

According to a first aspect of the invention, there is provided an image-output control device including: a detection unit that detects a predetermined image from a target image; and an output control unit that outputs menu display, which is a menu display that can receive selection of a process to be performed for the target image and the predetermined image, for each predetermined image detected from the target image to a predetermined output target. According to the image-output control device, even when a plurality of predetermined images is detected from the target image, menu display for each predetermined image is output to the output target. Accordingly, a user can recognize selection of a process appropriate to each predetermined image in an easy manner by watching the menu display, and thereby appropriate selection can be made.

In the above-described image-output control device, the output control unit may be configured to output the menu display, which has different items in accordance with the state of each detected predetermined image, for each predetermined image. In such a case, the menu display can arrange optimal items in accordance with the state of a corresponding predetermined image.

As an example, it may be configured that the detection unit detects a face image from the target image as the predetermined image, and the output control unit outputs the menu display corresponding to a face image, which is positioned in an approximately front direction, of the detected face image which includes an item of an identification photograph printing process. In addition, the output control unit may be configured to analyze color information for each detected predetermined image and output the menu display corresponding to a predetermined image, for which the result of analysis of the color information corresponds to a predetermined correction condition, which includes an item of a predetermined color correcting process. In addition, the output control unit may be configured to analyze a shape of each detected predetermined image and output the menu display corresponding to a predetermined image, for which the result of analysis of the shape corresponds to a predetermined correction condition, which includes an item of a predetermined shape correcting process. In such a case, the user does not need to be bothered for checking whether each predetermined image is appropriate as an ID photo, each predetermined image is to be corrected in color, or each predetermined image is to be corrected in shape. In addition, the user can recognize selection of a process that is appropriate to each predetermined image in an easy manner by viewing the items included in each menu display.

In the above-described image-output control device, the output control unit may be configured to output the target image and the menu display for each predetermined image in a state in which each common reference sign is assigned to the predetermined image and the menu display that are in correspondence with each other. In such a case, the user can visually recognize correspondence relationship between each predetermined image and corresponding menu display in an easy manner.

In the above-described image-output control device, the output control unit may be configured to print the target image and the menu display for each predetermined image on a printing medium. In such a case, the user can acquire so-called an order sheet in which the target image and menu display for each predetermined image are printed on one printing medium. However, the predetermined output target according to an embodiment of the invention is not limited to the printing medium, and the output control unit may be configured to output the target image and the menu display for each predetermined image to a predetermined screen.

The technical idea of the invention may be conceived as a method of controlling image output that includes the processing steps performed by the units of the above-described image-output control device or a program for controlling image output that allows a computer to perform functions corresponding to the units of the above-described image-output control device, in addition to the above-described image-output control device. In addition, the invention may be conceived as a printing device including: a detection unit that detects a predetermined image from a target image; and an output control unit that outputs menu display, which is a menu display that can receive selection of a process to be performed for the target image and the predetermined image, for each predetermined image detected from the target image to a predetermined output target.

### BRIEF DESCRIPTION OF THE DRAWINGS

The invention will be described with reference to the accompanying drawings, wherein like numbers reference like elements.

FIG. 1 is a schematic block diagram showing the configuration of a printer according to an embodiment of the invention.

FIG. 2 is a flowchart showing a process that is performed by the printer.

FIG. 3 is a flowchart showing a detailed face image detecting process according to an embodiment of the invention.

FIG. 4 is a diagram showing the appearance of setting a detection window according to an embodiment of the invention.

FIG. 5 is a diagram showing the appearance of calculating characteristic amounts based on window image data according to an embodiment of the invention.

FIG. 6 is a diagram showing an example of the structure of a neural network according to an embodiment of the invention.

FIG. 7 is a schematic diagram showing the appearance of building a neural network by learning according to an embodiment of the invention.

FIG. 8 is a diagram showing correspondence relationship between face images and items of menu UI according to an embodiment of the invention.

FIG. 9 is a diagram showing an example of an image that is output in a display unit according to an embodiment of the invention.

FIG. 10 is a diagram showing the appearance of setting a trimming frame on a target image, according to an embodiment of the invention.

FIG. 11 is a diagram showing an example of an order sheet according to an embodiment of the invention.

FIG. 12 is a schematic diagram showing a face existence determining process and a front face existence determining process according to an embodiment of the invention.

FIG. 13 is a diagram showing determination characteristics of the front face existence determining process.

### DESCRIPTION OF EXEMPLARY EMBODIMENTS

An embodiment of the invention will be described in the following order.

1. Schematic Configuration of Printer

2. Image Outputting Process
2-1. Detection of Face Image
2-2. Outputting Image to Display Unit
2-3. Process After Image Output

3. Modified Example

### 1. Schematic Configuration of Printer

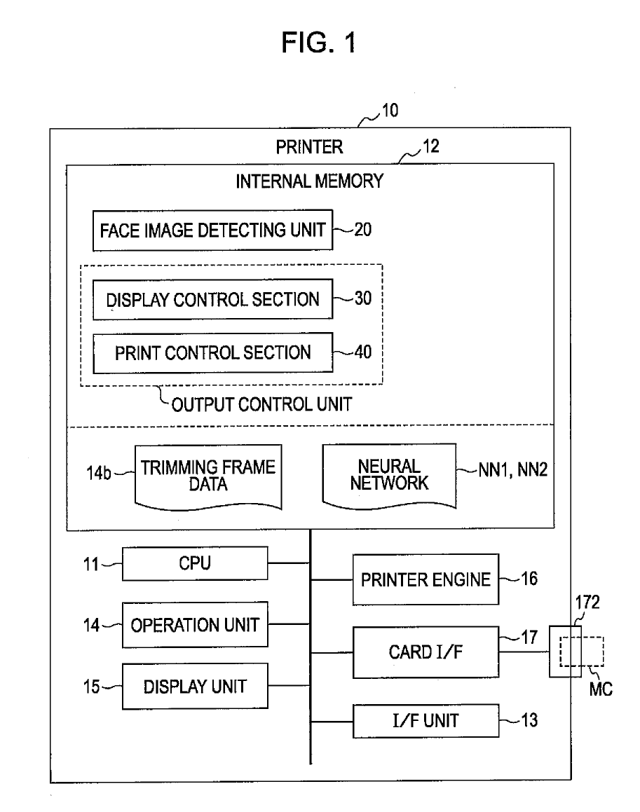

FIG. 1 schematically shows the configuration of a printer 10 as an example of an image-output control device and a printing device according to an embodiment of the invention. The printer 10 prints an image based on image data that is acquired from a recording medium (for example, a memory card MC or the like) and is a color ink jet printer corresponding to so-called direct printing. The printer 10 includes a CPU 11 that controls other units of the printer 10, an internal memory 12 that is, for example, configured by a ROM and a RAM, and operation unit 14 that is configured by buttons or a touch panel, a display unit 15 that is configured by a liquid crystal display, a printer engine 16, a card interface (card I/F) 17, and an I/F unit 13 for exchanging information with external devices such as a PC, a server or a digital still camera. The constituent elements of the printer 10 are interconnected through a bus. The display unit 15 corresponds to an example of a predetermined output target according to an embodiment of the invention.

The printer engine 16 is a printing mechanism that performs a printing operation based on print data. The card I/F 17 is an I/F used for exchange data with the memory card MC that is inserted into a card slot 172. In the memory card MC, image data is stored, and the printer 10 can acquire the image data that is stored in the memory card MC through the card I/F 17. As a recording medium used for providing the image data, various media other than the memory card MC can be used. It is apparent that the printer 10 can receive the image data as an input from the external devices, other than the recording medium, that are connected thereto through the I/F unit 13. The printer 10 may be a printing device that is dedicated for consumer use or may be an office printing device (so called a mini laboratory device) that is dedicated for DPE. The operation unit 14 and the display unit 15 may be an input operation unit (a mouse, a keyboard, or the like) or a display that is configured separated from a printer 10 main body. The printer 10 may receive the print data from a PC or a server that is connected thereto through the I/F unit 13.

In the internal memory 12, a face image detecting unit 20, a display control section 30 and a print control section 40 are stored. The face image detecting unit 20 is a computer program that is used for performing a face image detecting process to be described later under a predetermined operating system. The face image detecting unit 20 corresponds to an example of a detection unit according to an embodiment of the invention. The display control section 30 is a computer program for acquiring or generating an image such as a user interface (UI) image, which is used for receiving various directions from a user, a message, a thumb-nail image, or the like, to be output (displayed) in the display unit 15. In addition, the display control section 30 is also a display driver that controls the display unit 15 to display the UI image, the message, the thumb-nail image, or the like in a screen of the display unit 15. The print control section 40 is a computer program for generating the print data based on the image data and controls the printer engine 16 to print an image in a printing medium based on the print data. In addition, the print control section 40 controls the printer engine 16 to print an order sheet to be described later. The display control section 30 and the print control section 40 correspond to an output control unit according to an embodiment of the invention.

The CPU 11 implements the function of each of these units by reading out the program from the internal memory 12 and executing the program. In addition, in the internal memory 12, various types of data and programs such as trimming frame data 14b and neural networks NN1 and NN2 are stored. The printer 10 may be a multi-function device that has various types of functions such as a copy function, a scanner function (image reading-out function), in addition to the print function.

### 2. Image Outputting Process

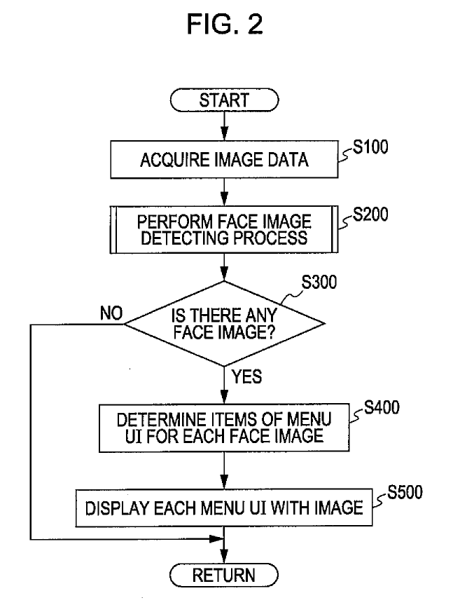

FIG. 2 is a flowchart showing an image outputting process that is performed by the printer 10. When a recording medium is inserted into the card slot 172, the printer 10 receives an image stored in the recording medium as input and displays the input image in the display unit 15 by using the display control section 30. Alternatively, when an image is input from the external device that is connected to the printer 10 through the I/F unit 13, the printer 10 displays the input image in the display unit 15 by using the display control section 30. The display unit 15 displays the input image in units of one sheet or displays a list of a plurality of input images. According to this embodiment, the image outputting process is performed in a scene in which the image is output to the display unit 15 as described above.

2-1. Detection of Face Image

In Step (hereinafter, notation of “Step” will be omitted) S100, the face image detecting unit 20 acquires image data D representing an image (target image) of one sheet to be processed from the recording medium or the external device, or the like. The image data D is bit map data that is formed from a plurality of pixels. Each pixel is represented as a combination of gray scales (for example, 256 gray scales of “0” to “255”) of RGB channels. The image data D may be compressed in a stage being recorded in a recording medium or the like, and colors of the pixels may be represented in a different color space. In such a case, the face image detecting unit 20 acquires the image data D as the RGB bit map data by expanding the image data D or performing conversion of the color space.

In S200, the face image detecting unit 20 detects a face image from the image data D. In this embodiment, a predetermined image is assumed to be an image of a person's face for descriptions. However, the predetermined image that can be detected by the configuration according to an embodiment of the invention is not limited to the image of a person's face. Thus, various targets such as artifacts, living things, natural objects, or landscapes can be detected as the predetermined image.

In S200, the face image detecting unit 20 can employ any technique, as long as it can detect a face image from the image data D. In this embodiment, as an example, detection is performed by using a neural network.

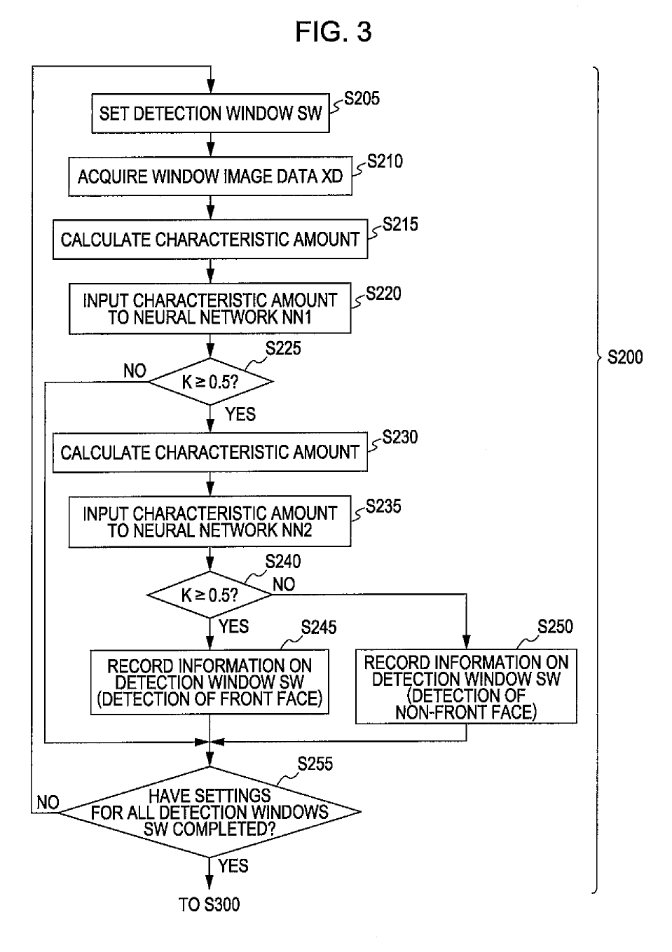

FIG. 3 is a flowchart showing a detailed process of S200.

In S205, the face image detecting unit 20 sets one detection window SW for the image data D. The detection window D is an area located on the image data D and becomes a target for detecting (determining existence of) a face image. In addition, the face image detecting unit 20 may be configured to reduce the size of the image data D before performing the process of S205. When detection of a face image is performed for the image data D of an original image size as a target, the process load is heavy. Thus, the face image detecting unit 20 reduces the image size of the image data D by decreasing the number of pixels of the image data or the like, and the process of S205 and thereafter is performed for the image data D after reduction as the target. The face image detecting unit 20, for example, reduces the image data D into a size (320 pixels×240 pixels) of QVGA (Quarter Video Graphics Array). Moreover, the face image detecting unit 20 may convert the image data D into a gray image before performing the process of S205. The face image detecting unit 20 converts the RGB data of each pixel of the image data D into a brightness value Y (0 to 255) and generates image data D as a monochrome image having one brightness value Y for each pixel. Generally, the brightness value Y can be calculated by adding R, G, and B together with predetermined weighting factors applied. The conversion of the image data D into a gray image is performed in advance in consideration of alleviation of the load at the time of calculating characteristic amounts to be described later. A method of setting the detection window SW is not particularly limited. However, as an example, the face image detecting unit 20 sets the detection window SW as below.

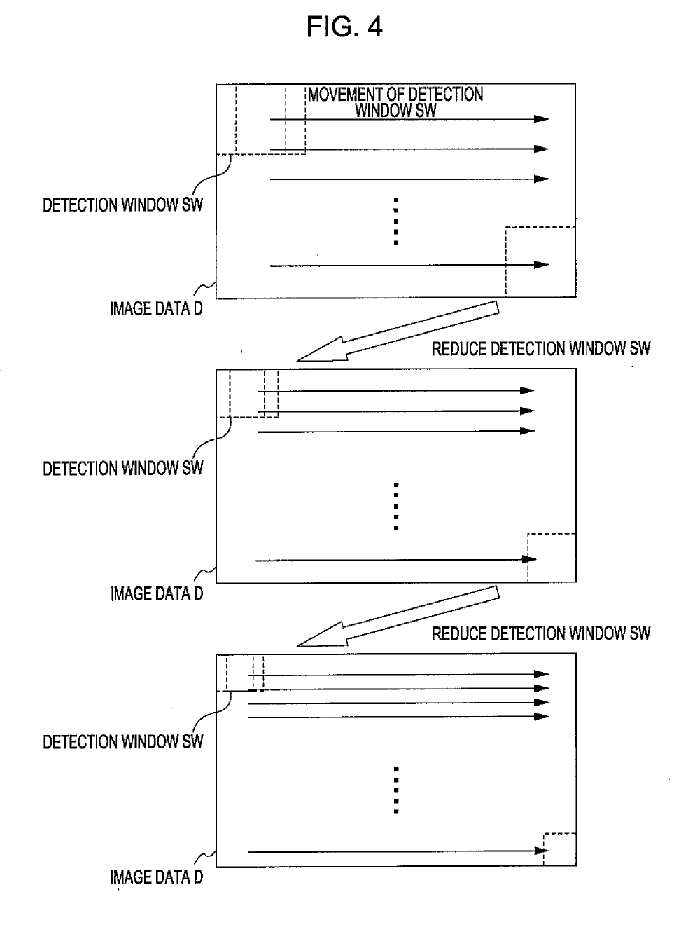

FIG. 4 shows the appearance of setting the detection window SW for the image data D. The face image detecting unit 20, in S205 for the first time, sets a detection window SW (denoted by a dashed-two dotted line) of a rectangular shape having a predetermined size including a plurality of pixels in a leading position (for example, a position located on the upper left corner of the image) within the image. Then, the face image detecting unit 20, in S205 for the second time and thereafter, moves the detection window SW from the position in which the detection window SW is set until then in the horizontal direction of the image or the vertical direction of the image by a predetermine distance (a predetermined number of pixels) and newly sets one detection window SW in the moved position. After repeatedly setting the detection window SW while moving the detection window SW to a final position (for example, a position located on the lower right corner of the image) of the image data D with the size of the detection window SW maintained, the face image detecting unit 20 sets the detection window SW back in the leading position.

When returning the detection window SW to the leading position, the face image detecting unit 20 sets a detection window SW of which the size of the rectangular is smaller than that up to that time. Thereafter, the face image detecting unit 20, same as described above, sets the detection window SW in each position while moving the detection window SW up to the final position of the image data D with the size of the detection window SW maintained. The face image detecting unit 20 repeats such movement and setting of the detection window SW while gradually reducing the size of the detection window SW for the number of times determined in advance. As described above, when one detection window SW is set in S205, the process of S210 and thereafter is performed.

In S210, the face image detecting unit 20 acquires image data (window image data) XD formed of pixels within the detection window SW which is set as the image data D in the previous S205.

In S215, the face image detecting unit 20 calculates a plurality of characteristic amounts based on the window image data XD acquired in the previous S210. These characteristic amounts can be acquired by applying various filters to the window image data XD and calculating characteristic amounts (an average value, a maximum value, a minimum value, and a standard deviation of brightness) that represent image characteristics such as an average brightness value, an edge amount, and contrast within the filters.

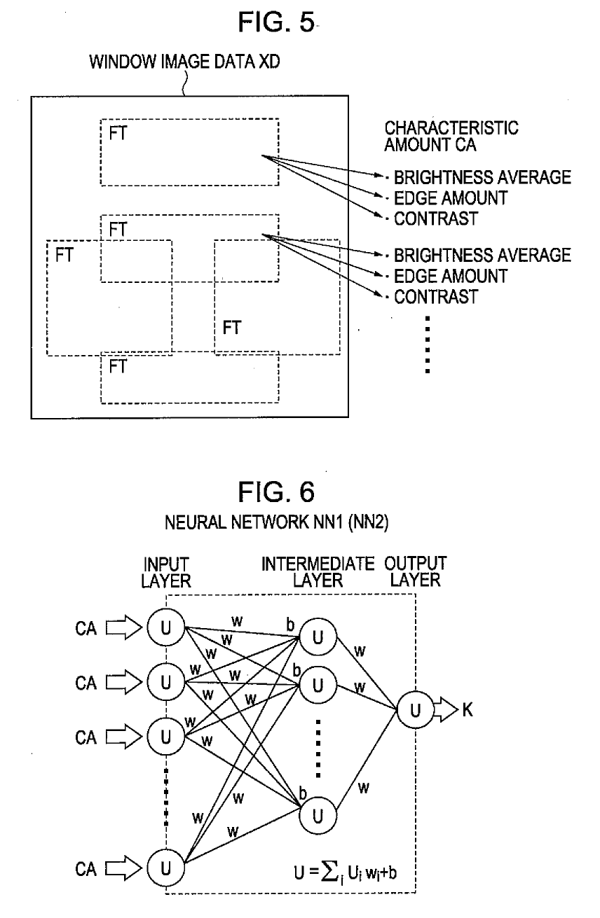

FIG. 5 shows the appearance of calculating the characteristic amounts based on the window image data XD. In the figure, a plurality of filters FT having different relative sizes and positions with respect to the window image data XD is prepared. Thus, by sequentially applying the filters FT to the window image data XD, a plurality of characteristic amounts CA, CA, CA . . . is calculated based on the image characteristics within the filters FT. In FIG. 5, each rectangular within the window image data XD is referred to as a filter FT. When the characteristic amounts CA, CA, CA . . . are calculated, the face image detecting unit 20 inputs the characteristic amounts CA, CA, CA . . . to a neural network NN1 prepared in advance in S220. Then, the result of determination on existence or non-existence of a face image is made based on the output of the neural network NN1.

FIG. 6 shows an example of the structure of the neural network NN1. The neural network NN1 has a basic structure in which a value of a unit U of the latter-level layer is determined based on a linear combination (here, a subscript is an identification number of a unit U of the former-level layer) of values of units U of the former-level layer. In addition, the value that is acquired by the linear combination may be directly set as a value of the unit U of the next layer. However, a non-linear characteristic may be implemented by determining the value of the unit U of the next layer by converting the value that is acquired by the linear combination using a non-linear function such as a hyperbolic tangent function. The neural network NN1 is configured by an outermost input layer, an output layer, and an intermediate layer that is interposed between the input layer and the output layer. The characteristic amounts CA, CA, CA . . . can be input to the input layer of the neural network NN1, and the output layer can output an output value K (a value normalized between 0 and 1). In S225, for example, when the output value K of the neural network NN1 is equal to or larger than 0.5, the face image detecting unit 20 determines that the output value is a value representing existence of a face image in the window image data XD, and the process proceeds to S230. On the other hand, when the output value K is smaller than 0.5, the face image detecting unit 20 determines that the output value is a value representing non-existence of a face image in the window image data XD, and the process proceeds to S255.

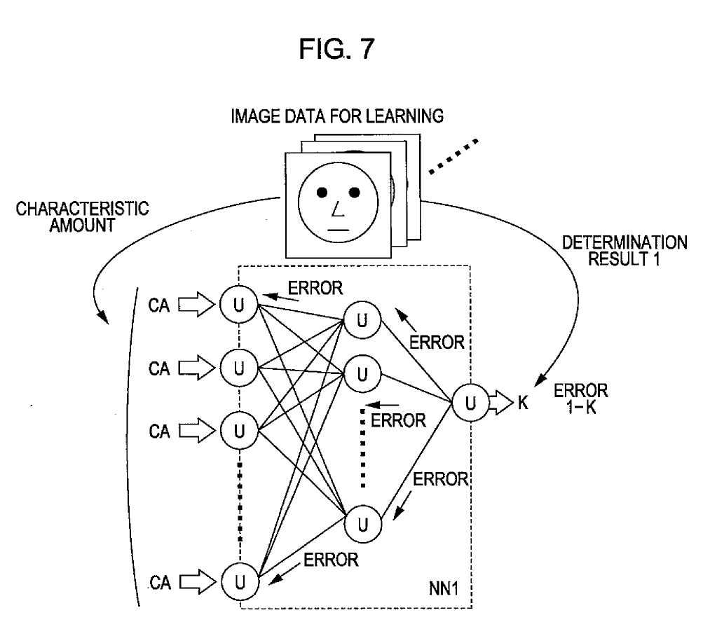

FIG. 7 schematically shows the appearance of building the neural network NN1 by learning. In this embodiment, by performing learning of the neural network NN1 by using an error back propagation method, the number of units U, the magnitudes of the weighting factors w for linear combination of the units U, and the value of a bias b are optimized. In learning by using the error back propagation method, first, the magnitudes of the weighting factors w for linear combination of the units U and the value of the bias b are initially set to appropriate values. Then, in determining whether a face image exists, for the known learning image data, the characteristic amounts CA, CA, CA . . . are calculated in the order of S215 and S220, the characteristic amounts CA, CA, CA . . . are input to the initially set neural network NN1, and the output value K is acquired. In this embodiment, it is preferable that “1” is output as the output value K for the learning image data in which a face image exists. In addition, it is preferable that “0” is output as the output value K for the learning image data (for example, image data in which an artifact and a landscape exist or the like) in which a face image does not exist.

However, the magnitudes of the weighting factors w and the value of the bias b for linear combination of the units U are only initially set to appropriate values. Thus, there is an error between an output value K that is acquired by inputting the characteristic amounts CA, CA, CA . . . of the learning image data and an ideal output value K (1 or 0). The weighting factors w for the units U and bias b for minimizing such an error are calculated by using a numerical optimizing technique such as a gradient technique. The above-described error propagates from the latter-level layer to the former-level layer, and thus, the weighting factors w and the bias b for the latter-level units U are sequentially optimized. In this embodiment, a “face image” is a concept including not only an image of a face photographed so as to face the front side but also an image of a face (a side face) facing the right or left side or a face (a turning up face or a turning down face) facing the upper or lower side. Accordingly, in the learning image data, in which a face image exists, that is used for learning of the neural network NN1, image data in which a face facing the right or left side exists, image data in which a face turning up or turning down exists, and the like are included, in addition to image data in which a face facing the front side exists. By preparing the neural network NN1 that is optimized by performing learning by using a plurality of learning image data inside the internal memory 12 in advance, it can be determined whether a face image exists in the window image data XD based on the characteristic amounts CA, CA, CA . . . .

When “Yes” is determined in S225, it can be determined that a face image exists in the detection window SW set in the previous S205. However, according to this embodiment, it is additionally determined whether the face image existing in the detection window SW is a “front face”. The front face means that a case where a face image facing the left or right side and a case where a face turning up or turning down, as described above, are excluded. In other words, the front face includes a case where a face image of which the direction of the face exactly faces the front side in the target image and a case where the face image of which the direction of the face is slightly deflected horizontally or vertically but all of the face organs (left and right eyes, the nose, and the mouth) face almost the front side, so that the face image can be used as an ID photo without any restriction.

In S230 to S240, the face image detecting unit 20 performs a same process as that of S215 to S225 by using a neural network NN2. In other words, the characteristic amounts CA, CA, and CA are acquired (S230. However, a filter FT that is applied to the window image data XD may be different from the filter FT that is used in S215) based on the window image data XD acquired in the previous S210, the acquired characteristics amounts CA, CA, and CA are input to the neural network NN2 that is conserved in the internal memory 12 in advance (S235), and the process is branched based on whether the output value K from the neural network NN2 is equal to or larger than a predetermined value (S240).

Both the neural network NN1 and the neural network NN2 have the basic structure as shown in FIG. 6. However, the relationship between learning image data that is used for learning performed in advance and the output value K is different for the neural networks NN1 and NN2. In other words, in order to build the neural network NN2 by learning, for determining whether a front face exists, the characteristic amounts CA, CA, CA . . . of the known learning image data are calculated, the characteristic amounts CA, CA, CA . . . are input to the neural network NN2 set initially, and the output value K is acquired. Then, the ideal value of the output value K for learning image data in which a front face exists is set to “1”. On the other hand, the ideal value of the output value K for learning image data (image data in which a side face exists, image data in which a face turning up exists, image data in which a face turning down exists, image data in which a subject completely different from a person's face exists, or the like) in which any front face does not exist is set to “0”. The weighting factors w and the bias b for each unit U are optimized as described above based on an error between an actual output value K acquired by inputting the characteristic amounts CA, CA, CA . . . of the learning image data and the ideal value. Thus, whether a front face exists in the window image data XD can be determined based on the characteristic amounts CA, CA, CA by preparing the neural network NN2, which is optimized by performing such learning using a plurality of learning image data, in the internal memory 12 in advance.

In S240, for example, when the output value K of the neural network NN2 is equal to or larger than “0.5”, the face image detecting unit 20 determines that the value represents existence of the front face in the window image data XD, and the process proceeds to S245. On the other hand, when the output value K of the neural network NN2 is smaller than 0.5, the face image detecting unit 20 determines that the value represents existence of a face image (non-front face) other than a front face in the window image data XD, and the process proceeds to S250.

In S245, after the face image detecting unit 20 associates information of the position (for example, the center position of the detection window SW in the image data D) and the size of the rectangle of the detection window SW set in the previous S205 with the image data D acquired in S100, the face image detecting unit 20 issues identification information representing a front face and records the information in a predetermined area of the internal memory 12. As described above, recording information on the detection window SW in which a front face is determined to exist corresponds to an example of detecting a front face. On the other hand, in S250, after the face image detecting unit 20 associates the information such as the position, the size, and the like of the detection window SW set in the previous S205 with the image data D acquired in S100, the face image detecting unit 20 attaches identification information representing a non-front face and records the information in a predetermined area of the internal memory 12. As described above, recording the information on the detection window SW in which a non-front face is determined to exist corresponds to an example of detection of a non-front face.

In S255, the face image detecting unit 20, under the idea of the method of setting the detection window SW described with reference to FIG. 4, moves the detection window SW and reduces the size of the detection window further or the like. Then, when there is room for setting the detection window SE still, the process returns back to S205, and one detection window SW is newly set in the image data D. On the other hand, when all the settings for the detection windows SW which can be made are completed by repeating reduction of the detection window SW for the predetermined number of times, the face image detecting unit 20 ends the process of S200. As a result, detection of a face image (a plurality of face images for a case where the plurality of faces exists) in the image data D is completed.

2-2. Image Output for Display Unit

In S300 (FIG. 2), the display control section 30 branches the process based on whether a face image exists in the image data D acquired in S100. When the information on the detection window SW for the image data D is recorded in the internal memory 12, the display control section 30 determines that a face image exists, and the process proceeds to S400. On the other hand, when any information on the detection window SW for the image data D is not recorded in the internal memory 12, the display control section 30 determines that any face image does not exist in the image data D and ends the flow shown in the flowchart of FIG. 2.

In S400, the display control section 30 determines items of a menu UI for each face image in accordance with the state of each detected face image (the information on the detection window SW which is recorded in the internal memory 12). The menu UT, as described below, is a UI that is output to the display unit 15 and is used for receiving selection of a process for the face image process for each item from a user. As a process for the face image, for example, there are an ID photo printing process, a color correcting process, a shape correcting process, and the like. The display control section 30 determines whether items of the process are to be assigned to each detected face image.

For example, the display control section 30 determines whether the item of the ID photo printing process is to be assigned in accordance with the identification information that is attached to the information on the detection window SW which is recorded in the internal memory 12. In other words, the display control section 30 reads out the information on the detection window SW which is recorded in the internal memory 12. Then, when the identification information representing a front face is attached in the read-out information, the display control section 30 assigns the item of “ID photo printing” to the information on the read-out detection window SW. On the other hand, when the identification information representing a non-front face is attached in the information of the detection window SW read out from the internal memory 12, the display control section 30 does not assign the item of “ID photo printing” to the information on the read-out detection window SW.

In addition, the display control section 30 interprets color information (for example, RGB) for an area of the image data D (referred to as face image data) that is represented by information on the detection window SW which is recorded in the internal memory 12 as a target. When the result of interpretation of color information corresponds to a predetermined color correcting condition, an item of the color correcting process is assigned to the information on the detection window SW. In addition, for example, when a red-eye area is detected by performing detection of so-called a red-eye area based on the color information of the face image data, the display control section 30 assigns an item of “red-eye correction” to the information on the detection window SW. For detection of a red-eye area, various known techniques may be employed, and a technique disclosed in JP-A-2007-156694 can be used. The “red-eye correction” is one type of the color correcting process.

In addition, the display control section 30 determines whether the face image is so-called color-blurred (red blurred or orange blurred) image based on the color information of the face image data. When a color-blurred image is determined, the display control section 30 assigns an item of “color-blur correction” to the information on the detection window SW. Whether an image is blurred can be determined, for example, based on relative deviations of average values Rave, Gave, and Bave of the histograms by generating the histograms for the R, G, and B. Among |Rave−Gave|, |Rave−Bave|, and |Bave−Gave| that are differences of average values Rave, Gave, and Bave, when |Rave−Gave| and |Rave−Bave| have a difference equal to or larger than |Bave−Gave|, Rave>Gave, and Rave>Bave, it can be determined that the face image data is in a red-blurred state or an orange-blurred state. In addition, the display control section 30 determines whether the face image data is a backlight image based on the color information of the face image data. When the face image is determined to be a backlight image, an item of “backlight correction” is assigned to the information on the detection window SW. Whether the face image is a backlight image is determined by generating a histogram of brightness (one type of the color information) of the face image data and analyzing the shape of the histogram. For example, in the histogram of the brightness, when the histogram is divided into a predetermined brightness range located on the low brightness side and a predetermined brightness range located on the high brightness side so as to form two distribution peaks, and the number of pixels constituting two peaks exceeds a predetermined reference number, the face image is determined to be a backlight image. The “color blur correction” or the “backlight correction” is one type of the color correcting process. As a technique for determining a color-blurred image or a backlight image, a technique other than the above-described technique may be used. In addition, the items of the color correcting process which are included in the menu UI are not limited to the above-described items.

In addition, the display control section 30 sets the face image data included in the information on the detection window SW which is recorded in the internal memory 12 as a target and analyzes the shape of a face image included in the face image data. When the result of analysis of the shape corresponds to a predetermined shape correcting condition, the display control section 30 assigns an item of the shape correction process to the information on the detection window SW. For example, the display control section 30 detects the height of a face (for example, a length between a top of the head to a chin) and the width of a face (for example, the width of a face at the height of a cheek) based on the face image data. When the ratio (L1/L2) of the height (L1) of the face to the width (L2) of the face is smaller than a predetermined threshold value, it can be assumed that the face image is a round face or an angled-cheek face. Accordingly, in such a case, it is determined that the shape corresponds to the shape correcting condition, and thus, an item of “small face correction” is assigned to the information on the detection window SW. The “small face correction” is one type of the shape correcting process. For example, the height (L1) of the face and the width (L2) of the face can be acquired based on the result of predetermined template matching for the face image data and the result of detection of peripheral edges of a face. Alternatively, a technique disclosed in JP-A-2004-318204 may be used for detecting the height (L1) of the face and the width (L2) of the face.

In addition, the display control section 30 may be configured to determine the gender of the face based on the face image data. In such a case, when the gender is female, it may be configured that an item of “small face correction” is assigned to the information on the detection window SW. In addition, when the size (a size ratio of the detection window SW to the image data D) of the face image data is smaller than a predetermined reference value, the display control section 30 may be configured to determine that the effect of the small face correction is not exhibited for most of the cases and not assign the item of the “small face correction” to the information on the detection window SW. The item of the shape correcting process which is described in the menu UI is not limited to the “small face correction”. For example, an item of “eye size correction” for changing the size of the eyes may be assigned to the information on the detection window SW in accordance with the result of detection (detection of an eye area) for an organ within the face image data and the result of size detection of the organ.

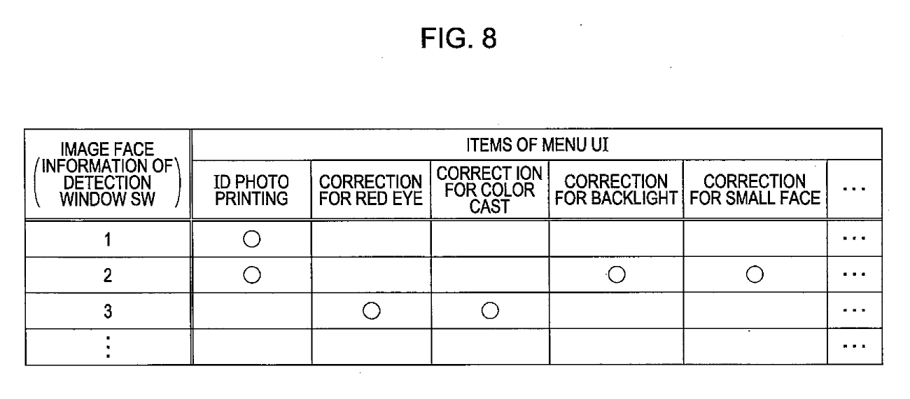

FIG. 8 shows one example of relationship between face images and the items of menu UI assigned by the display control section 30, as a table. In the table, numbers such as 1, 2, 3 . . . are assigned to the detected face images (information on each detection window SW which is recorded in the internal memory 12) for convenience, and the items of the menu UI which are assigned to the face images 1, 2, 3 . . . are specified by “o” marks.

In S500, the display control section 30 displays an image (target image) represented by the image data D acquired in S100 and the menu UI for each face image which is formed by items determined for each face image in S400 altogether on a screen of the display unit 15. The menu UI corresponds to one example of menu display in which selection of processes performed for a specific image can be received.

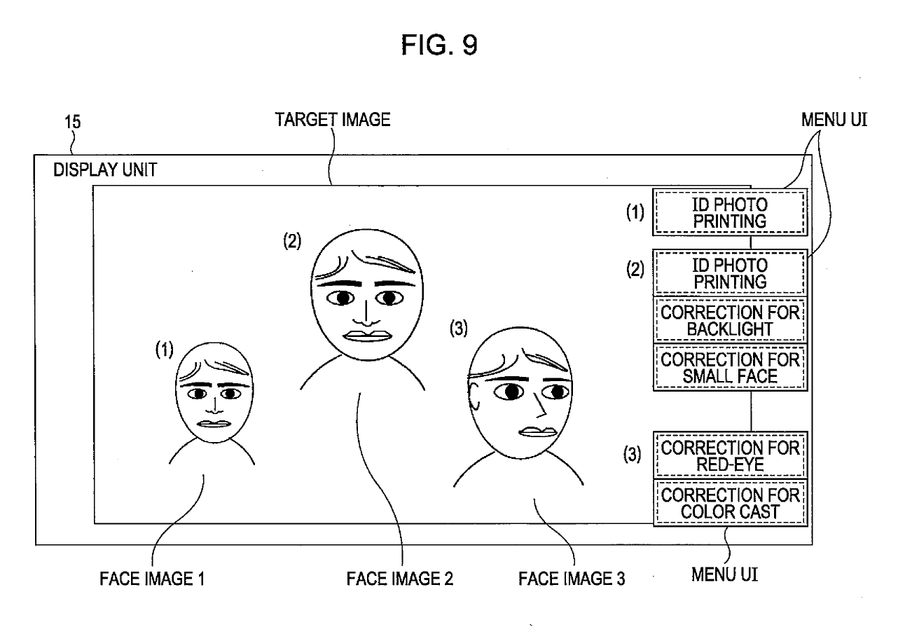

FIG. 9 shows an example of an image that is displayed in the display unit 15 by the display control section 30 in S500. As shown in FIG. 9, in the display unit 15, a target image (basically a thumbnail image of the target image) that is displayed based on the image data D and menu UIs for each face image included in the target image are shown. The target image displayed in the display unit 15 may be a color image or a monochrome image. The display control section 30 acquires image data representing the items that are saved in the internal memory 12 or the like in advance and displays menu UIs in the display unit 15 based on the acquired image data. The menu UI corresponding to one face image may be formed of one or a plurality of items that is assigned to the face image. The menu UI for example, is overlapped with corners of the target image to be displayed in the display unit 15.

FIG. 9 shows an example in which three face images 1 to 3 exist in the target image. When a plurality of face images exists in the target image as in this case, the display control section 30 displays common reference signs (a number, an alphabet, or the like) near a face image and a menu UI, which are in correspondence with each other, on the screen of the display unit 15. As a result, a user can visually recognize correspondence between a face image and a menu UI in an easy manner by watching the display unit 15. For example, the user can recognize that a menu UI corresponding to the face image 2 is a menu UI that is formed by items of “ID photo printing”, “backlight correction”, and “small face correction”. In addition, the display control section 30 may be configured to assign priorities to the items and display items having higher priorities only as the menu UI. For example, in a case where even a front face such as a face image 2 is also in correspondence with correction processes of the “backlight correction” and the “small face correction”, the items of the correction may be prioritized. Thus, in the display unit 15, the “back light correction” and the “small face correction” (for the case of the face image 2) may be displayed as the menu UT. Under such a configuration, when even a front face satisfies a condition for a color correcting process or a shape correcting process, the user can be urged to perform correction for appropriate colors and an appropriate shape before performing a printing process.

In addition, as the result of branching in S300, when the flow shown in the flowchart of FIG. 2 ends (“No” in S300), the display control section 30 displays the target image represented by the image data D that is acquired in S100 on the screen of the display unit 15. For the target image for which determination of “No” is made in S300, any menu UI is not displayed.

In FIG. 9, although an image received from a recording medium or the like is displayed in the display unit 15 as one sheet, however, the display control section 30 may be configured to display a list of a plurality of images that are received from the recording medium or the like. In other words, the printer 10 acquires images corresponding to a plurality of sheets as the target images from the recording medium or the like. Then, after performing the process of S100 to S400 for each acquired target image, the printer 10 simultaneously displays the target images corresponding to the plurality of sheets in the display unit 15. As a result, for a target image, which has face images, of the target images represented in the list, menu UIs for each face image are displayed together.

2-3. Process after Image Output

As described above, in the display unit 15, when a menu UT is displayed for a face image included in the target image, the user can direct the printer 10 a next operation by arbitrarily selecting an item within the menu UT through the operation unit 14. When detecting pressing on any item of the menu UT in the display unit 15 or detecting selection of any item of the menu UI in accordance with an operation of a predetermined button or the like, the printer 10 performs a process (printing an ID photo or correction of the red-eye, correction of the blurred color, correction of backlight, correction of a small face, correction of the eye size, or the like) corresponding to the selected item for an area of the image data D which includes at least a face image (face image data) corresponding to the menu UI including the selected item. The form of each process performed by the printer 10 is not particularly limited. For example, when the “red-eye correction” is selected, the printer 10 performs red-eye correction by using a known technique. When the “correction of the blurred color” is selected, the printer 10, for example, performs correction of gray scales of RGB so as to eliminate deviations of average values of the RGB histograms of the face image data. When the “backlight correction” is selected, the printer 10, for example, performs correction for increasing brightness values of pixels of the face image data. When the “small face correction” is selected, the printer 10, for example, determines areas on the periphery of left and right cheeks of the face image to be corrected and deforms the determined areas to be shrunken toward the center of the face. When the “correction of the eye size” is selected, the printer 10, for example, determines left and right eye areas of the face image to be corrected and deforms the determined areas of the eyes to be enlarged.

The display control section 30 may be configured to allow the user to check the result of correction by displaying the target image that includes a face image after the color correction or the shape correction as described above in the display 15 again. In order to display the target image again, the display control section 30 may be configured to determine new items of the menu UI for the face image included in the target image again and display the menu UI together.

In addition, when the “ID photo printing” is selected from the menu UI, the printer 10 transits to an ID photo printing mode. In the ID photo printing mode, the print control section 40 determines a rectangular area, of which the size ratio with respect to the detection window SW is determined in advance, including the detection window SW on its center from the image data D (the image data D before being converted into a gray image) based on the information on the detection window SW corresponding to the face image (for example, the face image 2) for which the “ID photo printing” is selected. The, the print control section 40 cuts out (trims) the determined rectangular area from the image data D. Then, the print control section 40 appropriately performs pixel-number conversion (enlargement or reduction) for the image data of the cut-out rectangular area in accordance with the size of the ID photo which is set in advance (or set by the user). The print control section 40 generates print data by performing a needed process such as a color converting process or a half-tone process for the image data after the pixel-number converting process.

The print control section 40 allows the printer engine 16 to perform printing based on the print data by supplying the generated print data to the printer engine 16. Accordingly, the printing process in the ID photo printing mode, that is, printing an ID photo having a front face is completed.

In addition, when transited to the ID photo printing mode, the printer 10 may allow the user to designate a trimming range without performing all the processes automatically until completion of printing the ID photo. When detecting transition to the ID photo printing mode, the display control section 30 reads out trimming frame data 14b from the internal memory 12. Then, the display control section 30 marks the trimming frame on the target image based on the trimming frame data 14b.

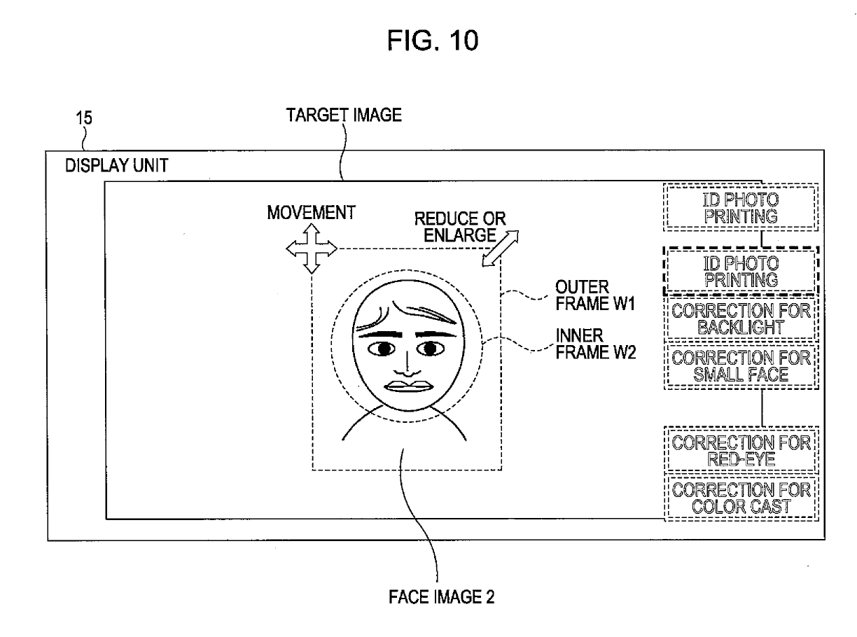

FIG. 10 shows an example of appearance of marking the trimming frame on the target image in the display unit 15. The trimming frame is formed of an outer frame W1 having a rectangular shape and an inner frame W2 having a circular shape that is placed inside the outer frame W1. The default shapes and default sizes of the outer frame W1 and the inner frame W2 and relative positional relationship between the outer frame W1 and the inner frame W2 are defined by the trimming frame data 14b. The user can direct the display control section 30 to move, enlarge, or reduce the trimming frame by operating the operation unit 14. The display control section 30 moves, enlarges, or reduces the trimming frame on the screen of the display unit 15 in accordance with the direction for movement, enlargement, or reduction. The display control section 30 performs movement, enlargement, or reduction of the outer frame W1 and the inner frame W1 such that the relative position and the size relationship of the outer frame W1 and the inner frame W2 are maintained.

The user directs movement, enlargement, or reduction of the trimming frame such that the entire front face (in the example of FIG. 10, the face image 2) located on the target image is inside the inner frame W2. Then, when the entire front face is appropriately placed inside the inner frame W2, the user notifies the printer 10 of determination of the trimming range by operating the operation unit 14. When receiving the direction for the determination, the printer 10 cuts out an image area of the trimming frame set on the display unit 15 which is surrounded by the outer frame W1 from the image data D of the target image and performs generation of the print data and printing based on the image data of the cut-out image area as described above. As a result, printing an ID photo having a front face is performed based on the trimming range that is designated by the user.

As described above, according to this embodiment, the printer 10 detects a face image from a target image, determines items (items representing processes to be performed for the face image) of the menu UI for each face image in accordance with the state of each detected face image, for example, that is, various states such as a front face or not, the color state, the shape, the gender, and the like, and displays the menu UI for each face image for which the items are determined as described above at a time when the target image is displayed in the display unit 15. In addition, when a plurality of face images is detected from the target image, reference signs common to a face image and a menu UI that correspond to each other are attached thereto in the display unit 15. As a result, when a recording medium is inserted into the printer 10, the user can visually recognize processes to be performed for each face image located on the target image in an easy manner by watching the target image output to the display unit 15. Accordingly, the user can select a process for each face image in a very easy manner.

### 3. Modified Example

In the description above, it is assumed that an output target of the target image and the menu display for each face image that is included in the target image is the screen of the display unit 15. However, the output target of the target image and the menu display may be a printing medium (printing sheet). In other words, the printer 10 may be configured to print (output) the target image and the menu display on the printing medium by controlling the printer engine 16 by using the print control section 40, in addition to (or instead of) displaying the menu UI-attached target image for each face image in the display unit 15 as a result of performing the process shown in FIG. 2. The user can use the printed material as so-called an order sheet.

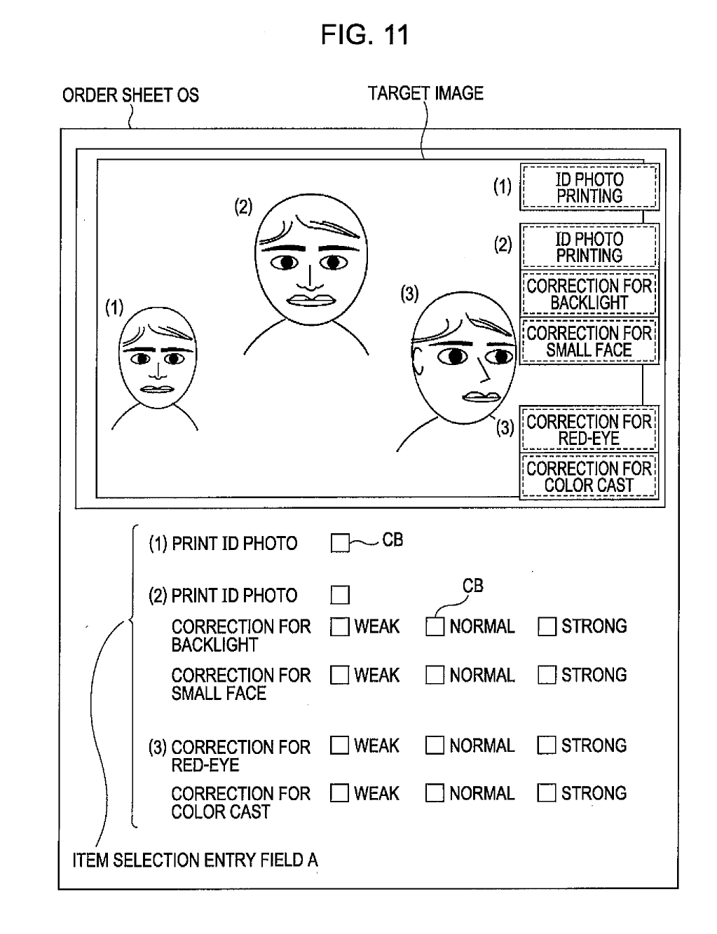

FIG. 11 shows an example of the order sheet OS printed by the printer 10. FIG. 11 shows a case where an image corresponding to the image in the display unit 15 shown in FIG. 9 as an example is printed as an order sheet OS. As shown in FIG. 11, in a marginal portion of the order sheet OS in which the target image is not printed, an item selection entry field A is printed. The item selection entry field A is configured to have a same item as that of the menu UI for each face image included in the target image. In addition, also in the item selection entry field A, the reference sign for each face image is printed, and items for each face image are arranged and printed in each position of the reference sign. In addition, in the item selection entry field A, one or a plurality of check boxes CB is printed for each item. The check box CB is an entry field that is used for receiving user's selection of the item and the degree (low, normal, high, or the like) of the color correction or the shape correction that is represented by the item. In other words, when the order sheet OS is printed, the print control section 40 performs a printing process with reference signs for each face image and items that are the same as those of the menu UI for each face image, and check boxes CB for the items disposed in the marginal portion. The item selection entry field A corresponds to an example of menu display that can receive selection of a process to be performed for a predetermined image. The design and the layout of the item selection entry field A shown in FIG. 11 is only an example, and the degree of each correction process is not limited to three levels.

The user can arbitrary select any check box CB on the order sheet OS and write a predetermined mark in the selected check box CB with a pen or the like. Then, for example, the user has the order sheet OS on which the mark is written read by an image reading unit (scanner) of the printer 10 that is not shown in the figure. When a predetermined mark is written in a check box CB on the order sheet OS that is read by the image reading unit, the printer 10 performs a process (a process on which the degree of correction indicated by the check box CB, in which the mark is written, is also reflected) indicated by the check box CB for the face image corresponding to the check box CB in which the mark is written.

When printing the order sheet OS, the printer 10 does not need to print both the menu UI and the item selection entry field A for each face image and may be configured to print any one of them. For example, a configuration in which a user writes a predetermined mark in a design of the menu UI that is printed on a printing medium and the image reading unit reads out the written mark from the design may be used.

When displaying a target image and the menu UI for each face image in the display unit 15, the printer 10 may be configured to display the above-described check box CB for each item as a part of the menu UI. Under such a configuration, designation for the degree of each correction process can be received from a user on the screen of the display unit 15.

Next, a technique other than the technique that uses the neural network in a face image detecting process that is performed by the face image detecting unit 20 in S200 will be described.

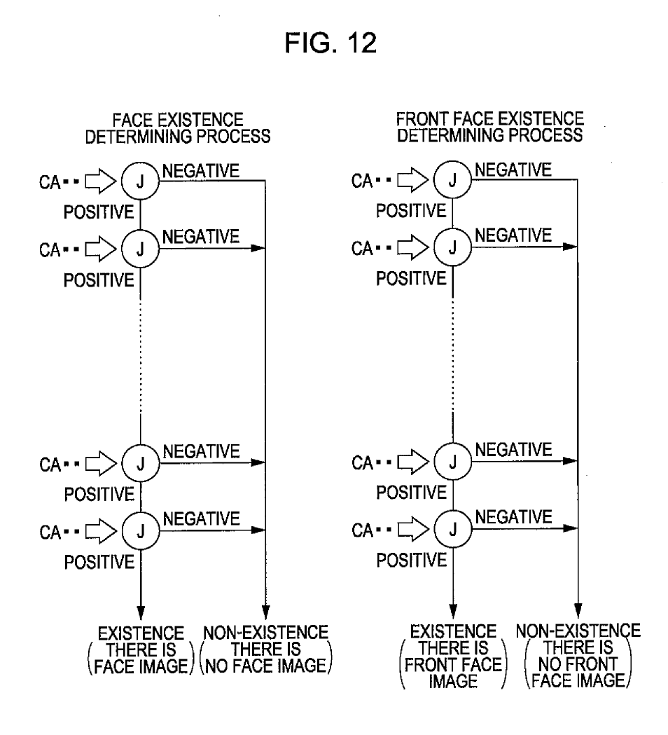

FIG. 12 schematically shows an example of the face existence determining process and a front face existence determining process that are performed by the face image detecting unit 20. The face image detecting unit 20 may be configured to perform the face existence determining process shown in FIG. 12 on the left side by replacing S215 to S225 (FIG. 3). In this face existence determining process, a determination unit formed by connecting a plurality of determinators J, J . . . in a cascade pattern for forming a plurality of stages is used. Here, the determination unit that is formed of the plurality of determinators J may be a physical device or a program that has determination functions described below corresponding to the plurality of determinators J. Each determinator J, J . . . receives one or a plurality of characteristic amounts CA, CA, CA . . . of different types (for example, filters FT are different) from the window image data XD as input and outputs positive determination or negative determination. Each determinator J, J . . . includes a determination algorithm for comparing the characteristic amounts CA, CA, CA . . . , determining a threshold value, or the like and performs independent determination on whether the window image data XD is like a face image (positive) or unlike a face image (negative). Each determinator J, J . . . of the next stage is connected to the positive output of the determinator J, J . . . of the previous stage. Thus, each determinator J, J . . . of the next stage performs determination only when the output of the determinator J, J . . . of the previous stage is positive. In any stage, at a time point when the negative output is made, the determination process ends, and determination of non-existence of a face image is output (in this case, the face image detecting unit 20 proceeds to S255). On the other hand, when all the determinators J, J . . . of each stage have positive output, the determination process ends, and determination of existence of a face image is output (in this case, the face image detecting unit 20 proceeds to S230)

Next, the face image detecting unit 20 performs the front face existence determining process shown in FIG. 12 on the right side by replacing S230 to S240 (FIG. 3). A determination unit that is used for the front face existence determining process basically has a same configuration as that of the determination unit that is used for the face existence determining process. However, when receiving one or a plurality of characteristic amounts CA, CA, CA . . . of different types (for example, the filters FT are different) from the window image data XD as input, determinators J, J . . . of the determination unit that is used for the front face existence determining process perform independent determination on whether the window image data XD is like a front face (positive) or unlike a front face (negative), which is different from the determination unit used for the face existence determining process. Accordingly, in the front face existence determining process, at a time point when negative output is made in any stage, the determination process ends, and determination of non-existence of a font face (a non-front face exists) is output (in this case, the face image detecting unit 20 proceeds to S250). On the other hand, when all the determinators J, J . . . of each stage have positive output, the determination process ends, and determination of existence of a front face image is output (in this case, the face image detecting unit 20 proceeds to S245).

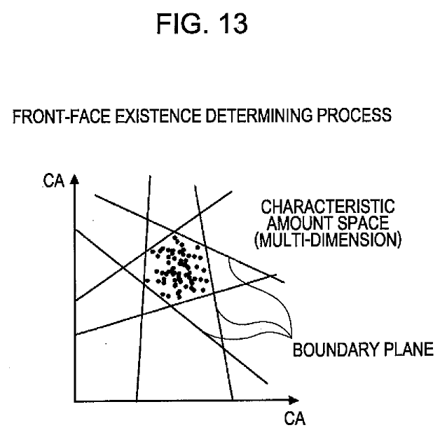

FIG. 13 shows determination characteristics of the determination unit that is used in the front face existence determining process. In the figure, a space of characteristic amounts that is defined by axes of the characteristic amounts CA, CA, CA . . . that are used in the above-described determinators J, J . . . is shown. In the figure, coordinates in the space of the characteristic amounts represented by a combination of the characteristic amounts CA, CA, CA . . . that are acquired from the window image data XD in which a front face is finally determined to exist are plotted. The window image data XD in which a front face is determined to exist has a specific characteristic and thus, can be considered to be distributed in a specific area in the space of the characteristic amounts. Each determinator J, J . . . generates a boundary plane in the space of the characteristic amounts. Then, when the coordinates of the characteristic amounts CA, CA, CA . . . for determination exist in the space belonging to the distribution within the space partitioned by the boundary plane, each determinator J, J . . . outputs positive. Accordingly, by connecting the determinators J, J . . . in a cascade pattern, the space for positive output can be decreased gradually. By using a plurality of the boundary planes, determination can be made with high accuracy for a distribution having a complicated shape. The distribution of coordinates in the space of the characteristic amounts represented by combinations of the characteristic amounts CA, CA, CA . . . that are acquired from the window image data XD in which a face image is determined to exist by the determination unit used in the face existence determining process is wider than the distribution shown in FIG. 13.

As above, an example in which the image-output control device and the method of controlling image output according to embodiments of the invention are implemented as the printer 10, and the program for controlling image output according to an embodiment of the invention is executed in cooperation with the printer 10 has been shown. However, the invention may be implemented in an image-output process by using an image device such as a computer, a digital still camera, a scanner, or a photo viewer. Moreover, the invention may be applied to an ATM (automated teller machine) or the like that performs a personal authentication. For the determination process of the face image detecting unit 20, various determination techniques in the characteristic amount space of the above-described characteristic amounts may be used. For example, a support vector machine may be used.

The present application claims the priority based on a Japanese Patent Application No. 2008-084249 filed on Mar. 27, 2008, the disclosure of which is hereby incorporated by reference in its entirety.

What is claimed is:

1. An image-output control device comprising:
a detection unit that detects a predetermined image from a target image; and
an output control unit that outputs menu display, which is a menu display that can receive selection of a process to be performed for the target image and the predetermined image, for each predetermined image detected from the target image to a predetermined output target.

2. The image-output control device according to claim 1, wherein the output control unit outputs the menu display, which has different items in accordance with the state of each detected predetermined image, for each predetermined image.

3. The image-output control device according to claim 2,
wherein the detection unit detects a face image from the target image as the predetermined image, and
wherein the output control unit outputs the menu display corresponding to a face image, which is positioned in an approximately front direction, of the detected face image which includes an item of an identification photograph printing process.

4. The image-output control device according to claim 2, wherein the output control unit analyzes color information for each detected predetermined image and outputs the menu display corresponding to a predetermined image, for which the result of analysis of the color information corresponds to a predetermined correction condition, which includes an item of a predetermined color correcting process.

5. The image-output control device according to claim 2, wherein the output control unit analyzes a shape of each detected predetermined image and outputs the menu display corresponding to a predetermined image, for which the result of analysis of the shape corresponds to a predetermined correction condition, which includes an item of a predetermined shape correcting process.

6. The image-output control device according to claim 1, wherein the output control unit outputs the target image and the menu display for each predetermined image in a state in which each common reference sign is assigned to the predetermined image and the menu display that are in correspondence with each other.

7. The image-output control device according to claim 1, wherein the output control unit prints the target image and the menu display for each predetermined image on a printing medium.

8. A method of controlling image output, the method comprising using a processor to perform the operation of:
detecting a predetermined image from a target image; and
outputting menu display, which is a menu display that can receive selection of a process to be performed for the target image and the predetermined image, for each predetermined image detected from the target image to a predetermined output target.

9. A computer program for image processing embodied on a computer-readable medium that allows a computer to perform functions including:
a detection function for detecting a predetermined image from a target image; and
an output control function for outputting menu display, which is a menu display that can receive selection of a process to be performed for the target image and the predetermined image, for each predetermined image detected from the target image to a predetermined output target.

10. A printing device comprising:
a detection unit that detects a predetermined image from a target image; and
an output control unit that outputs menu display, which is a menu display that can receive selection of a process to be performed for the target image and the predetermined image, for each predetermined image detected from the target image to a predetermined output target.
